(19) United States
(12) Patent Application Publication
(10) Pub. No.: US 2024/0193677 A1
(43) Pub. Date: Jun. 13, 2024

(54) SERVICE PROCESSING METHOD AND RELATED APPARATUS

(71) Applicant: HUAWEI TECHNOLOGIES CO., LTD., Shenzhen (CN)

(72) Inventors: Fangming LIU, Wuhan (CN); Xiaohan HUA, Shenzhen (CN); Lili LIU, Hangzhou (CN); Yu ZHOU, Hangzhou (CN)

(21) Appl. No.: 18/583,419

(22) Filed: Feb. 21, 2024

Related U.S. Application Data
(63) Continuation of application No. PCT/CN2022/112552, filed on Aug. 15, 2022.

(30) Foreign Application Priority Data
Aug. 23, 2021 (CN) 202110969022.9

(51) Int. Cl. G06Q 30/08

(52) U.S. Cl. CPC G06Q 30/08

(57) ABSTRACT

This application provides a service processing method and a related apparatus, and belongs to the field of cloud computing technologies. One example method includes, receiving a plurality of service requests, wherein the plurality of service requests indicate to process a plurality of services corresponding to a plurality of users, and each of the plurality of service requests indicates a cloud platform to process a service indicated by the respective service request; processing the plurality of services corresponding to the plurality of service requests, and bidding on resources applied for by the plurality of users; charging, based on a first price, a user that wins bidding and that is in the plurality of users; and charging, based on a second price, a user that loses the bidding and that is in the plurality of users.

### CROSS-REFERENCE TO RELATED APPLICATIONS

This application is a continuation of International Application No. PCT/CN2022/112552, filed on Aug. 15, 2022, which claims priority to Chinese Patent Application No. 202110969022.9, filed on Aug. 23, 2021. The disclosures of the aforementioned applications are hereby incorporated by reference in their entireties.

### TECHNICAL FIELD

This application relates to the field of cloud computing technologies, and in particular, to a service processing method and a related apparatus.

### BACKGROUND

Currently, a user may deploy a cloud service instance on a cloud platform, and the cloud platform runs the cloud service instance to process a service. The cloud service instance may be, for example, a cloud function or a container. The cloud function is a function that runs on a cloud. The function includes program code that is used to implement one feature or a set of features. A cloud function service is a function hosting computing service. A basic principle for implementing the cloud function service is that a user account deploys a service-related function on the cloud platform, and the cloud platform runs the function deployed by the user account through a resource provided by the cloud platform. The cloud function service brings convenience to the user, that is, the user does not need to manage and maintain underlying infrastructure such as a server. This helps improve development efficiency of the user account.

Currently, a problem of low resource utilization often occurs on the cloud platform.

### SUMMARY

Embodiments of this application provide a service processing method and a related apparatus, to improve resource utilization of a cloud platform. The technical solutions are as follows.

According to a first aspect, a service processing method is provided, where the method is applied to a cloud platform. The method includes: receiving a plurality of service requests, where the plurality of service requests indicate to process a plurality of services corresponding to a plurality of users, and each service request indicates the cloud platform to process a service indicated by the service request; processing a plurality of services corresponding to the plurality of service requests, and bidding on resources applied for by the plurality of users, where a resource applied for by each user is used to process a service that corresponds to each user and that is in the plurality of services; charging, based on a first price, a user that wins bidding and that is in the plurality of users, where a value of the first price is related to bids of some or all of the plurality of users, and the first price is lower than a bid of any user that wins the bidding and that is in the plurality of users; and charging, based on a second price, a user that loses the bidding and that is in the plurality of users, where the second price is higher than the first price.

That the first price is related to the bidding means that the first price is fluctuating, the first price is affected by bids of some or all users participating in the bidding, and the first price varies with the bids. For example, usually, if a bid of each user participating in the bidding is high, the first price is high, and if the bid of each user participating in the bidding is low, the first price is low. Therefore, dynamic charging of a service is implemented. This allows the user to have an opportunity to determine a price of the service through bidding, helps the user save costs, and helps attract more users to process a service through the cloud platform. In this way, waste of an idle resource on the cloud platform is alleviated, resource utilization of the cloud platform is improved, and energy is saved.

The cloud platform still continues processing on a service corresponding to the user that loses the bidding and that is in the plurality of users. Specifically, the cloud platform does not interrupt a service of a user due to a bidding failure of the user. For example, if the cloud platform has started processing a service of a user, but the user loses the bidding, the cloud platform continues processing the service of the user, and charges the user based on the second price. In this way, in one aspect, service interruption caused by a bidding failure is avoided, and service processing performance of the cloud platform is ensured. In another aspect, if bidding is performed in a manner of interrupting a service, the cloud platform needs to save a service status when the service is interrupted, and subsequently restores to process the service based on the service status. However, storing and restoring the service status cause great overheads, and implementation complexity is high. However, in the foregoing manner, because a service is not interrupted due to a bidding failure, overheads caused by service interruption are reduced, and implementation complexity is reduced.

In a word, in the method provided in the first aspect, a resource used for processing a service is provided in a bidding manner, and a user that wins a bidding is charged at a price that is related to a bid and that is lower than the bid. This allows the user to have an opportunity to determine a price of the service through bidding, helps the user save costs, and helps attract more users to process a service through the cloud platform. In this way, waste of an idle resource on the cloud platform is alleviated, resource utilization of the cloud platform is improved, and energy is saved. In addition, a service of a user that loses the bidding is not interrupted. This ensures service processing performance of the cloud platform, and avoids overheads caused by storing and restoring a service status.

In a possible implementation, the plurality of services corresponding to the plurality of service requests include a batch processing service; and the processing the plurality of services corresponding to the plurality of service requests includes: allocating a first resource in a first time period to the batch processing service, where the first time period is a time period in which resource usage of the cloud platform is lower than a threshold, and the first resource is idle in the first time period; and processing the batch processing service by using the first resource within the first time period.

In this manner, in one aspect, the batch processing service seldom interacts with the outside. Therefore, a specific time period in which the batch processing service is executed has little impact on the batch processing service. In this way, the user may run the batch processing service at a low price when there are a large quantity of idle resources, to save costs. For the platform, this method can guide the user to migrate more types of batch processing services to the platform. Therefore, services of the platform are expended, and benefits of both the user and the platform are considered. In another aspect, idle resources are sold to the batch processing service at a low price in a time period when there are a large quantity of idle resources on the platform. This attracts the batch processing service to use resources when the platform is idle, improves resource utilization of the platform when the platform is idle, and implement peak shaving and valley filling of the resource utilization.

In a possible implementation, the first time period is determined based on a change status of the resource usage of the cloud platform during historical use.

For example, a change status of resource usage of the cloud platform in a past day is obtained, and it is found that resource usage from 12 p.m. to 6 a.m. of a next day is less than a threshold, and 12 p.m. to 6 a.m. of the next day is used as the first time period. The first time period is determined based on the change status of the resource usage during historical use, to ensure that the first time period matches an actual historical use status of the cloud platform, and the first time period is more accurate.

In a possible implementation, the plurality of services corresponding to the plurality of service requests include an online service; and the processing the plurality of services corresponding to the plurality of service requests includes: allocating a second resource to the online service in real time, where a quantity of second resources is related to a first price, and processing the online service by using the second resource.

In this way, in one aspect, a more stable online service is also provided with a right to bid. When bidding is successful, resources allocated to the online service may obtain a specific discount, so that more profits are brought to the user, and more users are indirectly brought to the platform. Therefore, overall usage of the platform is improved. In another aspect, because a quantity of resources obtained by the online service through bidding is restricted, a quantity of resources offered at a discount to the online service may be adjusted based on a profit obtained by bidding (for example, a profit obtained through selling idle resources). This helps avoid a negative profit of the platform.

In a possible implementation, the plurality of users include a first user, whether the first user wins the bidding is related to a value of a first cloud service instance, the first cloud service instance is a cloud service instance used when a service corresponding to the first user is processed, the value of the first cloud service instance indicates a benefit brought by the first cloud service instance to the cloud platform and a benefit brought by the first cloud service instance to the first user, and the value of the first cloud service instance is related to at least one of a bid of the first user, resource usage of the first user, and a quantity of times that the first cloud service instance is invoked.

A bid of a user is converted into a value of a cloud service instance, and a user that wins bidding is selected based on the value of the cloud service instance. In one aspect, this helps avoid a problem of a poor bid result due to an unreasonable bid when the user that wins the bidding is selected based on the bid. In another aspect, because a benefit of the user and a benefit of the platform are considered in the value of the cloud service instance, a win-win between the platform and the user is implemented in a bid result.

In a possible implementation, the value of the first cloud service instance is directly proportional to the bid of the first user, the value of the first cloud service instance is inversely proportional to the resource usage of the first user, and the value of the first cloud service instance is directly proportional to the quantity of times that the first cloud service instance is invoked.

In a possible implementation, the first price is related to the value of the first cloud service instance.

In this manner, factors such as a bid, resource usage of a user, or a quantity of times that a cloud service instance is invoked may affect pricing of the cloud service instance. In this way, users are attracted to participate in bidding and guided to use more cloud service instances. Therefore, resource utilization is improved.

In a possible implementation, the plurality of users include a first user, whether the first user wins the bidding is related to a bid of the first user and resource usage of the first user, and the first price is further related to the resource usage of the first user.

In this bidding manner, for two users who offer a same bid, a user with lower resource usage is more likely to win the bidding than a user with higher resource usage. Therefore, the user with the lower resource usage is more likely to obtain a discount. It can be learned that this bidding manner has a large preference for a user with low resource usage, to compensate the user with the low resource usage. In this manner, the user with the low resource usage is compensated for a loss caused by paying for an unused resource.

In a possible implementation, the plurality of users include a first user, whether the first user wins the bidding is related to a bid of the first user and a quantity of times that a first cloud service instance is invoked, the first price is further related to the quantity of times that the first cloud service instance is invoked, and the first cloud service instance is a cloud service instance used when a service corresponding to the first user is processed.

In this bidding manner, for users who offer a same bid, a user with a larger quantity of times that a cloud service instance is invoked is more likely to win the bidding than a user with a smaller quantity of times that a cloud service instance is invoked. Therefore, the user with the larger quantity of times that the cloud service instance is invoked is more likely to obtain a discount. It can be learned that this bidding manner has a large preference for a cloud service instance that is invoked for a large quantity of times, helps a user with large usage of a cloud service instance reduce costs, and avoids a problem of cost explosion that may occur after usage increases.

In a possible implementation, the first cloud service instance is a function, a container, or a virtual machine. Optionally, the first cloud service instance is another instance that uses serverless.

In a possible implementation, the bidding is triggered in at least one of the following manners: a time triggering manner, a resource usage triggering manner, or an event triggering manner.

The time triggering manner means that bidding is performed when time reaches a specified time point. For example, if a manner in which bidding is regularly performed is used, bidding is performed every time a specified time period elapses. If the time period is, for example, one hour, bidding is performed at intervals of one hour. For another example, if a manner in which a user specifies bidding time is used, bidding is performed when time reaches the bidding time specified by the user.

The resource usage triggering manner indicates that bidding is performed when resource usage is lower than a threshold. For example, if the threshold of the resource usage is set to n %, the resource usage of the cloud platform is monitored. If the resource usage of the cloud platform is lower than n %, bidding starts.

The event triggering manner means that bidding is performed when a specified event occurs. For example, bidding is performed when a notification message is received. For another example, bidding is performed when a bidding request of user equipment is received. For another example, bidding is performed when data required for service processing is collected.

The foregoing provides a variety of bidding methods to improve flexibility.

According to a second aspect, a service processing apparatus is provided, where the service processing apparatus is disposed on a cloud platform, and the service processing apparatus has a function of implementing any one of the first aspect or the optional manners of the first aspect. The service processing apparatus includes at least one unit, and the at least one unit is configured to implement the method provided in any one of the first aspect or the optional manners of the first aspect. In some embodiments, units in the service processing apparatus are implemented by using software, and the units in the service processing apparatus are program modules. In some other embodiments, units in the service processing apparatus are implemented by using hardware or firmware. For specific details of the service processing apparatus provided in the second aspect, refer to the first aspect or any optional manner of the first aspect. Details are not described herein again.

According to a third aspect, a computing device is provided. The computing device includes a processor and a memory, where the memory stores computer instructions, and the processor executes the computer instructions, to implement the method in the first aspect and the possible implementations of the first aspect.

According to a fourth aspect, a computer-readable storage medium is provided. The storage medium stores at least one instruction, and when the instruction is run on a computer, the computer is enabled to perform the method provided in any one of the first aspect or the optional manners of the first aspect.

According to a fifth aspect, a computer program product is provided. The computer program product includes one or more computer program instructions, and when the computer program instructions are loaded and run by a computer, the computer is enabled to perform the method provided in any one of the first aspect or the optional manners of the first aspect.

According to a sixth aspect, a chip is provided, including a memory and a processor, where the memory is configured to store computer instructions, and the processor is configured to invoke and run the computer instructions from the memory, to perform the method in any one of the first aspect and the possible implementations of the first aspect.

### BRIEF DESCRIPTION OF DRAWINGS

FIG. 1 is a schematic diagram of a typical application scenario according to an embodiment of this application;

FIG. 2 is a flowchart of a service processing method according to an embodiment of this application;

FIG. 3 is a system architectural diagram of a FaaS platform according to an embodiment of this application;

FIG. 4 is a service processing flowchart of a FaaS platform according to an embodiment of this application;

FIG. 5 is a service processing flowchart of a FaaS platform according to an embodiment of this application;

FIG. 6 is a change trend diagram of usage of a FaaS platform according to an embodiment of this application;

FIG. 7 is a flowchart of resource bidding according to an embodiment of this application;

FIG. 8 is a schematic diagram of a structure of a service processing apparatus according to an embodiment of this application; and

FIG. 9 is a schematic diagram of a structure of a computing device according to an embodiment of this application.

### DESCRIPTION OF EMBODIMENTS

To make the objectives, technical solutions, and advantages of this application clearer, the following further describes the implementations of this application in detail with reference to the accompanying drawings.

The following explains and describes some terms and concepts in embodiments of this application.

### (1) Serverless Architecture

A serverless architecture does not mean computing without a server. Instead, a developer may use a related resource without learning a status of an underlying server. This is referred to as serverless. The serverless architecture may also be identified from a broader perspective. A cloud service that may be directly used without configuring and learning an underlying server may also be referred to as serverless to some extent.

### (2) Cloud Function

A cloud function is a function that runs on a cloud (server). The function includes program code that is used to implement one feature or a set of features. The cloud function runs by occupying a specific quantity of resources such as a central processing unit (CPU), a memory, and the like. Optionally, a physical form of the cloud function is one or more files. There are many types of services processed by using the cloud function. For example, the services processed by using the cloud function include file processing, data extract-transform-load (ETL) processing, mobile and web application back-ends, artificial intelligence (AI) inference prediction, and the like. For example, in an image processing scenario, the cloud function is, for example, a function used to perform operations such as cropping, adding a watermark, and adjusting a size on an image. For another example, in an AI inference prediction scenario, the cloud function is, for example, an invocation function for a trained AI model.

### (3) Cloud Function Service

A cloud function service is a function hosting computing service. A basic principle of the cloud function service is that a user writes code for a cloud function in a language supported by a FaaS platform and submits the code of the cloud function to the FaaS platform, and the FaaS platform automatically runs the code wrote by the user through a computing resource of the FaaS platform. The cloud function service provides the user with a serverless execution phase, and helps the user run code without purchasing or managing a server, so that the user is free from a complicated development and configuration of the server. In this way, a research and development threshold is lowered, and service construction efficiency is improved. A fee of the cloud function service is usually generated after running of the cloud function is complete. If the cloud function is not running, the fee is not generated.

### (4) Online Service

An online service usually interacts with the outside, and the online service cannot be stopped during running. For example, the online service turns on or off an air conditioner in response to a request of a user. A platform does not learn when the user sends a request. Therefore, the platform needs to be online in real time and waits for the user to send the request.

### (5) Batch Processing Service

Batch processing refers to batch processing of an object, and the object may be data, an image, a video, and the like. A batch processing service is usually not real-time, needs to be processed within a specified period of time, does not interact with the outside, and may be stopped at any time. For example, the batch processing service is machine learning. When a machine learning service is processed by using a cloud function, content of the function is machine learning, input of the function is a pile of collected data sets, and during execution of the function, collected data is read from a database, and a result is output to the database after the function is calculated.

### (6) Service Deployer

A service deployer refers to a user that deploys a cloud service instance on a cloud platform. The cloud platform processes a corresponding service for the service deployer by invoking the cloud service instance deployed by the service deployer. When the cloud platform processes a service, specific resources are used, and the cloud platform charges the service deployer for the used resources. In some embodiments of this application, the service deployer sets a bid for a resource, and triggers a bidding request, to participate in a resource bidding process.

### (7) Service User

A service user refers to a user that uses a service deployed by a service deployer, and the service user is an initiator of a service request. For example, for a game service, the service deployer is, for example, a game developer, and the service user is, for example, a player.

In the following description, unless otherwise specified, a user refers to a service deployer, and a service corresponding to the user refers to a service processed by a cloud platform for a service deployer. A mapping between users and services may be one-to-one or one-to-many. For example, a user and a service have a one-to-many relationship. For example, the service deployer is a game developer, the game developer provides a game A, a game B, and a game C, and services corresponding to the game developer include the game A, the game B, and the game C.

Some embodiments of this application relate to the field of cloud computing serverless (serverless) technologies. The following describes a development status of the serverless technology.

The serverless technology refers to a computing service in which computing is fully managed, and a user only needs to write code to build and develop an application without managing and maintaining underlying infrastructure such as a server. The serverless technology has been developing rapidly in recent years, and mainstream cloud computing vendors are promoting development of the serverless technology. As a specific implementation of the serverless technology, a cloud function has been increasingly used in recent years.

Although the serverless technology can help a user improve development efficiency, the serverless technology still has many disadvantages, and a resource waste is a main disadvantage. 1. The serverless technology is in an initial stage, and a quantity of users is not very large; and most of resources in a platform are not well used, and a large quantity of resources are wasted. 2. Compared with a cloud data center, the serverless technology can improve resource utilization to some extent, but the serverless technology still cannot resolve a peak-to-valley problem of resource utilization; and peak-to-valley fluctuation still causes resource idleness for a considerable period of time, that is, a part of resources are wasted. The user also faces a resource waste. To be specific, resources applied for by the user cannot be fully used when the resources are invoked, resulting in a waste in the resources. However, the user pays extra fees for these resources. This is unfair for the user.

In view of this, some embodiments of this application provide a mechanism in which a user uses a resource in a bidding manner, to implement dynamic charging of a serverless service (such as a cloud function), and help the user reduce costs and process more services at a same price. To resolve a problem of low resource usage of a platform and large fluctuation in a peak of resource usage, some embodiments of this application provide a mechanism in which an idle resource is provided for a user at a low price, to guide the user to calculate some batch processing services during a time period when there are a large quantity of idle resources on the platform. This helps the platform implement peak shaving and valley filling of the resource usage, and improves resource utilization of the platform. In view of unfairness to the user caused by the fact that resources actually used by the user are less than resources purchased by the user, dynamic charging is implemented through bidding, to allow the user to have an opportunity to determine a use price of the resources. Therefore, the user has an opportunity to obtain more resources at a same price, and costs are saved. In this way, a problem of unfair charging to the user is alleviated, and cost explosion is prevented.

The following uses an example to describe an application scenario of embodiments of this application.

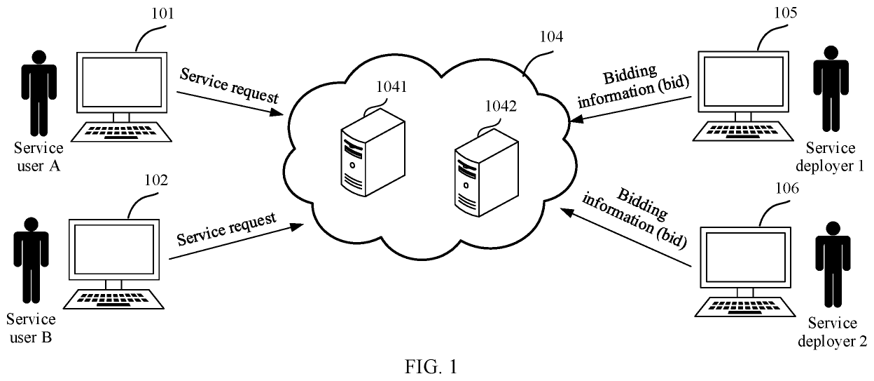

The application scenario of embodiments of this application includes interaction between a cloud platform and a plurality of user equipments. For example, refer to FIG. 1. The application scenario shown in FIG. 1 includes user equipment 101, user equipment 102, a cloud platform 104, user equipment 105, and user equipment 106. The user equipment 101 and the user equipment 102 are user equipments used by a service user, and the user equipment 105 and the user equipment 106 are user equipments used by a service deployer.

The following describes devices in FIG. 1 by using an example.

### (1) User Equipment 101

The user equipment 101 is configured to: response to an operation triggered by a service user A, generate a service request, and initiate the service request to the cloud platform 104, to use a service provided by a service deployer 1.

Optionally, browser software or service client software is installed on the user equipment 101. The user equipment 101 initiates the service request through the browser software or the service client software.

### (2) User Equipment 102

The user equipment 102 is configured to: response to an operation triggered by a service user B, generate a service request, and initiate the service request to the cloud platform 104, to use a service provided by a service deployer 2.

### (3) User Equipment 105

The user equipment 105 is configured to upload data or code of a cloud service instance of the service deployer 1 to the cloud platform 104, to deploy the cloud service instance of the service deployer 1 on the cloud platform 104.

In addition, the user equipment 105 is further configured to receive bidding information input by the service deployer 1, for example, a bid of the service deployer 1, information about a resource applied for by the service deployer 1, and a bidding trigger condition. The user equipment 105 initiates a bidding request to the cloud platform 104 based on the bidding information input by the service deployer 1, to help the service deployer 1 participate in a bidding process.

### (4) User Equipment 106

The user equipment 106 is configured to upload data or code of a cloud service instance of the service deployer 2 to the cloud platform 104, to deploy the cloud service instance of the service deployer 2 on the cloud platform 104.

In addition, the user equipment 106 is further configured to receive bidding information input by the service deployer 2, for example, a bid of the service deployer 2, information about a resource applied for by the service deployer 2, and a bidding trigger condition, and the user equipment 106 initiates a bidding request to the cloud platform 104 based on the bidding information input by the service deployer 2, to help the service deployer 2 participate in a bidding process.

### (5) Cloud Platform 104

The cloud platform 104 is configured to: receive service requests sent by the user equipment 101 and the user equipment 102, and process services corresponding to the service deployer 1 and the service deployer 2.

Specifically, in response to the service request of the user equipment 101, the cloud platform 104 invokes the cloud service instance deployed by the service deployer 1, and processes a service by using the cloud service instance deployed by the service deployer 1. In response to the service request of the user equipment 102, the cloud platform 104 invokes the cloud service instance deployed by the service deployer 2, and processes a service by using the cloud service instance deployed by the service deployer 2.

The cloud platform 104 has a plurality of possible product forms. For example, the cloud platform 104 includes but is not limited to an independent physical server, a server cluster including a plurality of physical servers, or a distributed system including a plurality of physical servers. In FIG. 1, an example in which the cloud platform 104 includes a server 1041 and a server 1042 is used for description.

A scenario in which there are two user equipments shown in FIG. 1 is merely an example for description, and a quantity of user equipments may optionally be more or less. For example, there are dozens or hundreds of user equipments, or there are more user equipments. The quantity of user equipments is not limited in this embodiment.

User equipments shown in FIG. 1 have a plurality of possible product forms. For example, the user equipments include but are not limited to a personal computer, a mobile phone, a server, a notebook computer, an IP phone, a camera, a tablet computer, a wearable device, and the like. The user equipments are connected to the cloud platform through a wired network or a wireless network.

The following uses an example to describe a method procedure in embodiments of this application.

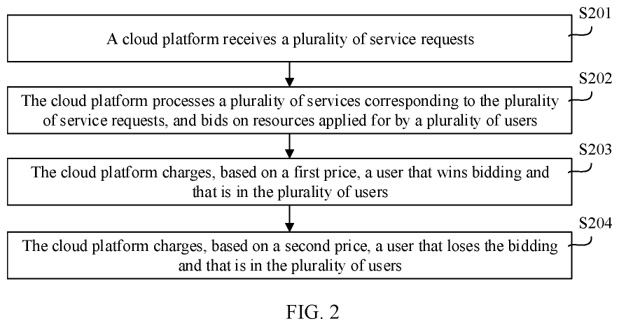

FIG. 2 is a flowchart of a service processing method according to an embodiment of this application. The method shown in FIG. 2 includes the following steps S201 to S204.

The method shown in FIG. 2 is applied to a cloud platform. For example, with reference to FIG. 1, the method shown in FIG. 2 is executed by the cloud platform 104 in FIG. 1. In the method shown in FIG. 2, a plurality of service requests include a service request that is sent by the user equipment 101 and that is from the service user A, and a service request that is sent by the user equipment 102 and that is from the service user B.

A typical application scenario for the method shown in FIG. 2 is providing a cloud function service. Optionally, the method shown in FIG. 2 is applied to another cloud service other than a cloud function service in the cloud computing field, for example, applied to providing a container service or a virtual machine service.

Prices in different cases are included in a process of the method shown in FIG. 2. To distinguish different prices, a “first price” is used to describe a price when bidding is successful, and a “second price” is used to describe a price when the bidding fails.

Resources allocated by the cloud platform for different services are included in the process of the method shown in FIG. 2. To distinguish different resources, a “first resource” is used to describe a resource allocated to a batch processing service, and a “second resource” is used to describe a resource allocated to an online service.

Step S201: The cloud platform receives a plurality of service requests.

The plurality of service requests indicate to process a plurality of services corresponding to a plurality of users. For example, the service request is sent by user equipment, and the service request is triggered by a service user by performing an operation on the user equipment.

Each service request indicates the cloud platform to process a service indicated by the service request.

Optionally, the service request includes a service type, and the service type indicates whether a to-be-processed service is a batch processing service or an online service.

Optionally, the service request includes a quantity of resources applied for by a user. The resources include but are not limited to a computing resource, a storage resource, and a network resource. The computing resource includes but is not limited to a CPU and a memory, and the storage resource includes but is not limited to a hard disk. The hard disk is, for example, a solid state disk (SSD) or a hard disk drive (HDD). The network resource includes but is not limited to bandwidth and a network adapter. When the resource is a memory, a quantity of resources is, for example, a memory size, for example, 32 GB. When the resource is a CPU, a quantity of resources is, for example, a quantity of CPUs.

Optionally, the service request includes a bid of the user. The bid of the user indicates a price that the user pays for the resource that is applied for.

Step S202: The cloud platform processes the plurality of services corresponding to the plurality of service requests, and bids on resources applied for by the plurality of users, where a resource applied for by each user is used to process a service that corresponds to each user and that is in the plurality of services.

Specifically, the cloud platform invokes a cloud service instance deployed by the user, runs the cloud service instance by using the resource applied for by the user, and the cloud service instance processes a service.

The cloud service instance includes but is not limited to a function, a container, or a virtual machine. Alternatively, the cloud service instance is another instance that uses serverless.

Step S203: The cloud platform charges, based on a first price, a user that wins bidding and that is in the plurality of users.

The first price is also referred to as a transaction price or set price. A value of the first price is related to bids of some or all of users of the plurality of users. That the first price is related to the bidding means that the first price is fluctuating, the first price is affected by bids of some or all users participating in the bidding, and the first price varies with the bids. For example, usually, if a bid of each user participating in the bidding is high, the first price is high, and if the bid of each user participating in the bidding is low, the first price is low. Therefore, dynamic charging of a service is implemented. This allows the user to have an opportunity to determine a price of the service through bidding, helps the user save costs, and helps attract more users to process a service through the cloud platform. In this way, waste of an idle resource on the cloud platform is alleviated, resource utilization of the cloud platform is improved, and energy is saved.

The first price is lower than a bid of any user that wins the bidding and that is in the plurality of users. For the user that wins the bidding, a price of a resource is lower than a bid. Therefore, costs are saved, and users are attracted to participate in the bidding.

Step S204: The cloud platform charges, based on a second price, a user that loses the bidding and that is in the plurality of users.

The second price is higher than the first price. For example, the second price is a preset original price of a resource.

The cloud platform still continues processing on a service corresponding to the user that loses the bidding and that is in the plurality of users. Specifically, the cloud platform does not interrupt a service of a user due to a bidding failure of the user. For example, if the cloud platform has started processing a service of a user, but the user loses the bidding, the cloud platform continues processing the service of the user, and charges the user based on the second price.

In this way, in one aspect, service interruption caused by a bidding failure is avoided, and service processing performance of the cloud platform is ensured. In another aspect, if bidding is performed in a manner of interrupting a service, the cloud platform needs to save a service status when the service is interrupted, and subsequently restores to process the service based on the service status. However, storing and restoring the service status cause great overheads, and implementation complexity is high. However, in the foregoing manner, because a service is not interrupted due to a bidding failure, overheads caused by service interruption are reduced, and implementation complexity is reduced.

In particular, bidding is performed in a manner of not interrupting a service. This manner matches a feature of a cloud function, and is more applicable to a scenario in which a cloud function service is provided. Specifically, a function is a more-fine-grained resource unit compared with a virtual machine. It is easy for the virtual machine to save and restore a status. However, the function has a shorter running lifecycle (compared with the virtual machine). As a result, it is difficult for the function to save and restore a status of the function. First, managing the status of the function needs extra technical and operation costs. Second, overheads of storing and restoring the status of the function are high due to a short lifecycle of the function. Therefore, if bidding is performed in a manner of interrupting a service, the platform needs to save and restore a status for more times, and extra overheads are largely caused. Bidding is performed in a manner of providing a preferential price (the first price) instead of interrupting a service, to avoid huge overheads caused by storing and restoring a status of a function by the platform.

According to the method provided in this embodiment, a resource used for processing a service is provided in a bidding manner, and a user that wins bidding is charged at a price that is related to a bid and lower than the bid. This allows the user to have an opportunity to determine a price of the service through bidding, helps the user save costs, and helps attract more users to process a service through the cloud platform. In this way, waste of an idle resource on the cloud platform is alleviated, resource utilization of the cloud platform is improved, and energy is saved. In addition, a service of a user that loses the bidding is not interrupted. This ensures service processing performance of the cloud platform, and avoids overheads caused by storing and restoring a service status.

The following describes a specific processing procedure of a batch processing service in the method shown in FIG. 2.

For example, the plurality of services corresponding to the plurality of service requests received in the step S201 include the batch processing service. The step S202 includes: allocating a first resource in a first time period to the batch processing service; and processing the batch processing service by using the first resource within the first time period.

The first time period is a time period in which resource usage of the cloud platform is less than a threshold. In other words, the first time period is a time period in which the cloud platform is idle. For example, the first time period is a time period of late night or early morning. The first resource is idle in the first time period. Specifically, the first resource is an unoccupied resource of the cloud platform in the first time period.

In this manner, the batch processing service seldom interacts with the outside. Therefore, a specific time period in which the batch processing service is executed has little impact on the batch processing service. In this way, the user may run the batch processing service at a low price when there are a large quantity of idle resources, to save costs. For the platform, this method can guide the user to migrate more types of batch processing services to the platform. Therefore, services of the platform are expended, and benefits of both the user and the platform are considered. In addition, idle resources are sold to the batch processing service at a low price in a time period when there are a large quantity of idle resources on the platform. This attracts the batch processing service to use resources when the platform is idle, improves resource utilization of the platform when the platform is idle, and implement peak shaving and valley filling of the resource utilization.

There are many manners of determining the first time period. Optionally, the first time period is determined based on a change status of the resource usage of the cloud platform during historical use. Specifically, resource usage of the cloud platform in a future time period is predicted based on a change status of resource usage of the cloud platform in each historical time period, and a time period in which resource usage is lower than a threshold is determined, based on a prediction result, as the first time period. A prediction manner is, for example, using a prediction model or a deep learning model. For example, a change status of resource usage of the cloud platform in a past day is obtained, and it is found that resource usage from 12 p.m. to 6 a.m. of a next day is less than a threshold, and 12 p.m. to 6 a.m. of the next day is used as the first time period.

The first time period is determined based on the change status of the resource usage during historical use, to ensure that the first time period matches an actual historical use status of the cloud platform, and the first time period is more accurate.

Alternatively, the first time period is a time period specified by the user. For example, the first time period is a time period carried in a service request. Alternatively, the first time period is a default time period set by an administrator of the cloud platform. A manner of determining the first time period is not limited in this embodiment.

The following describes a specific processing procedure of an online service in the method shown in FIG. 2.

For example, the plurality of services corresponding to the plurality of service requests received in the step S201 include the online service. The step S202 includes: allocating a second resource to the online service in real time; and processing the online service by using the second resource.

Real-time allocation is that, for example, resource allocation is performed within a specific period of time after a service request is received.

A quantity of second resources is related to the first price. For example, the quantity of the second resources is positively correlated with the first price. Optionally, the quantity of the second resources is determined based on a profit obtained by selling an idle resource (namely, the first resource) of the cloud platform. Specifically, the quantity of the second resources is determined based on a product (namely, a profit) of the first resource and the first price. For example, the quantity of the second resources=the first resource×the first price/a price of the second resource. For another example, the quantity of the second resources=(the first resource×the first price/a price of the second resource)×a weight. A value range of the weight is (0, 1). When the weight is 1, an extra profit obtained by providing an idle resource is returned to the online service in a form of discount. When the platform wants to make more profits, the weight may be lowered to reduce a quantity of preferential resources for the online service.

In this way, in one aspect, a more stable online service is also provided with a right to bid. When bidding is successful, resources allocated to the online service may obtain a specific discount, so that more profits are brought to the user, and more users are indirectly brought to the platform. Therefore, overall usage of the platform is improved. In another aspect, because a quantity of resources obtained by the online service through bidding is restricted, a quantity of resources offered at a discount to the online service may be adjusted based on a profit obtained by bidding (for example, a profit obtained through selling idle resources). This helps avoid a negative profit of the platform.

The following describes how to select a user that wins bidding from a plurality of users participating in the bidding and how to determine a price of a service of the user that wins the bidding. For ease of understanding, the following uses a first user as an example for description. The first user is one of the plurality of users participating in the bidding. For an implementation of another user other than the first user, refer to an implementation of the first user.

For ease of description, the following describes, as a first cloud service instance, a cloud service instance used when a service corresponding to the first user is processed. Optionally, the first cloud service instance is a function, a container, or a virtual machine deployed by the first user on a cloud platform. Alternatively, the first cloud service instance is another instance implemented based on a serverless technology. A specific form of the first cloud service instance is not limited in embodiments.

In some embodiments, whether the first user win bidding is related to a value of the first cloud service instance.

A value of the first cloud service instance is also referred to as a virtual value. The value of the first cloud service instance indicates a benefit brought by the first cloud service instance to the cloud platform and a benefit brought by the first cloud service instance to the first user. The value of the first cloud service instance is related to at least one of a bid of the first user, resource usage of the first user, and a quantity of times that the first cloud service instance is invoked.

The value of the first cloud service instance is data obtained by evaluating a bid of a user and historical data of the first cloud service instance. For example, the value of the first cloud service instance is data obtained based on two types of data: the bid of the user and resource usage of the user. For another example, the value of the first cloud service instance is data obtained based on two types of data: the bid of the user and a quantity of times that the first cloud service instance is invoked. For another example, the value of the first cloud service instance is data obtained based on three types of data: the bid of the user, resource usage of the user, and a quantity of times that the first cloud service instance is invoked.

In some embodiments, the value of the first cloud service instance is directly proportional to the bid of the first user, the value of the first cloud service instance is inversely proportional to the resource usage of the first user, and the value of the first cloud service instance is directly proportional to the quantity of times that the first cloud service instance is invoked.

A bid of a user is converted into a value of a cloud service instance, and a user that wins bidding is selected based on the value of the cloud service instance. In one aspect, this helps avoid a problem of a poor bid result due to an unreasonable bid when the user that wins the bidding is selected based on the bid. In another aspect, because a benefit of the user and a benefit of the platform are considered in the value of the cloud service instance, a win-win between the platform and the user is implemented in a bid result.

There are many manners for determining the resource usage of the first user. Optionally, the resource usage of the first user is an average value of resource usage of the first cloud service instance each time invoked by the first user in a historical process. Alternatively, the resource usage of the first user is an average value of resource usage of the first cloud service instance invoked by the first user in recent times.

The quantity of times that the first cloud service instance is invoked is, for example, an average value of quantities of times that the first cloud service instance is invoked by the first user each time in a historical process. The quantity of times that the first cloud service instance is invoked reflects usage of the cloud service instance by the first user. Alternatively, the quantity of times that the first cloud service instance is invoked may be replaced with duration in which the first cloud service instance is invoked.

Optionally, the first price is related to the value of the first cloud service instance. In this manner, factors such as a bid, resource usage of a user, or a quantity of times that a cloud service instance is invoked may affect pricing of the cloud service instance. In this way, users are attracted to participate in bidding and guided to use more cloud service instances. Therefore, resource utilization is improved.

In some embodiments, whether the first user wins the bidding is related to a bid of the first user and resource usage of the first user. For example, a probability that the first user wins the bidding is positively correlated with the bid of the first user, and the probability that the first user wins the bidding is negatively correlated with the resource usage of the first user. In addition, the first price is not only related to the bid, but also to the resource usage of the first user.

In this bidding manner, for two users who offer a same bid, a user with lower resource usage is more likely to win the bidding than a user with higher resource usage. Therefore, the user with the lower resource usage is more likely to obtain a discount. It can be learned that this bidding manner has a large preference for a user with low resource usage, to compensate the user with the low resource usage. In this manner, the user with the low resource usage is compensated for a loss caused by paying for an unused resource.

In some embodiments, whether the first user wins the bidding is related to a bid of the first user and a quantity of times that the first cloud service instance is invoked. For example, a probability that the first user wins the bidding is positively correlated with the bid of the first user, and the probability that the first user wins the bidding is positively correlated with the quantity of times that the first cloud service instance is invoked. In addition, the first price is not only related to the bid, but also related to the quantity of times that the first cloud service instance is invoked.

In this bidding manner, for users who offer a same bid, a user with a larger quantity of times that a cloud service instance is invoked is more likely to win the bidding than a user with a smaller quantity of times that a cloud service instance is invoked. Therefore, the user with the larger quantity of times that the cloud service instance is invoked is more likely to obtain a discount. It can be learned that this bidding manner has a large preference for a cloud service instance that is invoked for a large quantity of times, helps a user with large usage of a cloud service instance reduce costs, and avoids a problem of cost explosion that may occur after usage increases.

The foregoing describes factors that are related to whether the first user wins the bidding. For details about how to determine whether the first user wins the bidding, refer to content in example 1 or example 2 below. Optionally, for each user participating in the bidding, whether each user wins the bidding is determined in a same manner as that of the first user. Alternatively, for some users participating in the bidding, whether the some users win the bidding is determined in a same manner as that of the first user.

In this embodiment, there are many manners of triggering the bidding. In some embodiments, the bidding is triggered in at least one of the following manners: a time triggering manner, a resource usage triggering manner, or an event triggering manner.

The time triggering manner means that the bidding is performed when time reaches a specified time point. For example, if a manner in which the bidding is regularly performed is used, the bidding is performed every time a specified time period elapses. If the time period is, for example, one hour, the bidding is performed at intervals of one hour. For another example, if a manner in which a user specifies bidding time is used, the bidding is performed when time reaches the bidding time specified by the user.

The resource usage triggering manner indicates that the bidding is performed when resource usage is lower than a threshold. For example, if the threshold of the resource usage is set to n %, the resource usage of the cloud platform is monitored. If the resource usage of the cloud platform is lower than n %, bidding starts.

The event triggering manner means that the bidding is performed when a specified event occurs. For example, the bidding is performed when a notification message is received. For another example, the bidding is performed when a bidding request of user equipment is received. For another example, the bidding is performed when data required for service processing is collected.

The following uses a cloud function scenario as an example to describe the method shown in FIG. 2. In the following embodiment, the cloud function is an example of the cloud service instance in the method shown in FIG. 2, a preferential price is a description of the first price in the method shown in FIG. 2, and an original price is a description of the second price in the method shown in FIG. 2.

The following describes a system architecture of a cloud platform.

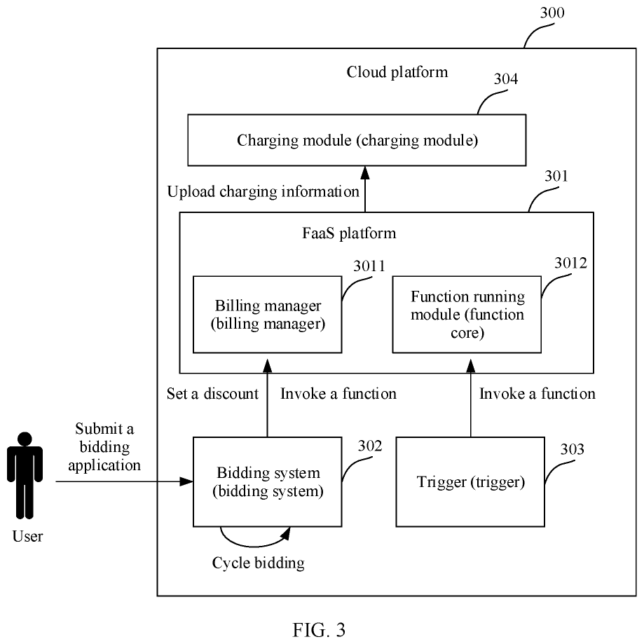

FIG. 3 is a system architectural diagram of a cloud platform 300 according to an embodiment of this application. As shown in FIG. 3, the cloud platform 300 includes a function as a service (FaaS) platform 301, a charging module 304, a bidding system 302, and a trigger 303.

The function as a service (FaaS) platform 301 includes a billing manager 3011 and a function running module (or function core) 3012.

The billing manager 3011 is configured to: collect statistics on charging data, and upload the charging data to the charging module 304. Specifically, function execution of a cloud function service is usually triggered through a specific trigger condition. Optionally, billing manners of all functions are the same, and the all functions are uniformly charged after a worker (worker, for example, a process or a node device) reports running data of the functions.

The function running module 3012 is configured to run a cloud function. In an example, the function running module 3012 is configured to: when an event is triggered, allocate a resource to the cloud function, and start a running environment (such as a container or a virtual machine) of the function to run the cloud function.

The trigger 303 is configured to generate an event. The event generated by the trigger 303 is transferred to the cloud function, to trigger the cloud function to run. Optionally, the trigger 303 pushes the generated event to the function running module 3012, to trigger the function running module 3012 to run the cloud function. Alternatively, the function running module 3012 pulls an event from the trigger 303, and triggers the cloud function to run based on the event.

The charging module 304 is configured to perform charging based on the charging data.

The bidding system 302 is a new module introduced in the FaaS platform 301 according to some embodiments of this application. The bidding system 302 is optionally responsible for running all logic associated with bidding. The bidding system 302 performs bidding at regular intervals. Functions of the bidding system 302 include setting a bidding resource size, selecting a successful bidder, setting a preferential price, starting a batch processing function resource, and the like.

The following functions (1) to (3) may be implemented by using the system architecture shown in FIG. 3.
(1) Classify and process different functions and services.
(2) Allow a batch processing service to select time for participating in bidding, to implement peak shaving and valley filling; and allow an online service to obtain a discount through bidding, to reduce development costs of a user and attract more users to use the FaaS platform.
(3) The FaaS platform can properly control a discount on the online service based on extra revenues of the batch processing service. In this way, the FaaS platform always makes profits, and allows the user to obtain more computing resources at the same time. Therefore, a win-win is implemented.

The following describes a service processing procedure of the FaaS platform. The procedure described below is applied to the system architecture shown in FIG. 3. The service processing procedure of the FaaS platform includes the following step 1 to step 4.
Step 1: The FaaS platform selects a to-be-executed batch processing service.

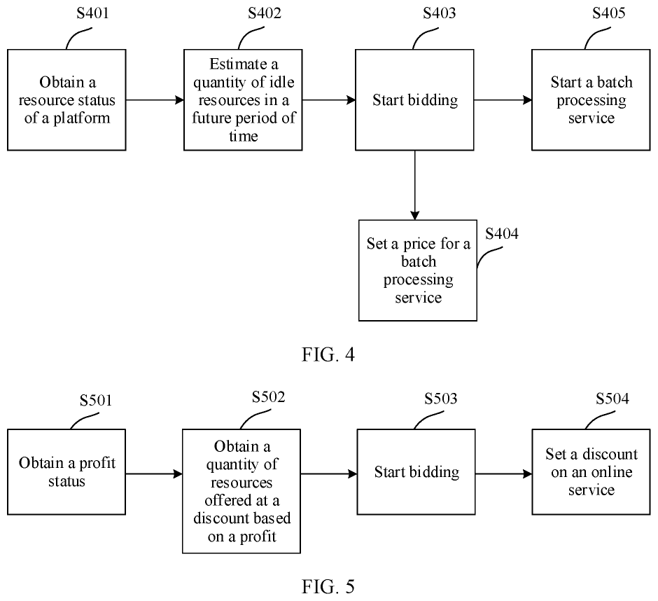

As shown in S401 to S402 in FIG. 4, a bidding system monitors system resource usage, and predicts a quantity of idle resources in a future period of time based on the resource usage. The bidding system obtains a specific proportion of resources from the idle resources and sells the obtained idle resources to some batch processing services at a low price. A user sets a bidding application in a process such as inputting function information, setting a bid, and setting continuous working period on user equipment. The user equipment generates a service request based on a setting operation of the user, and the service request includes the bidding application. As shown in S403 to S404 in FIG. 4, after receiving the service request, the bidding system starts bidding selection based on the bidding application carried in the service request. When a quantity of applied resources is less than a quantity of the obtained idle resources, the bidding system directly sells the idle resources to the batch processing services at a specific low price. When the quantity of the applied resources is greater than the quantity of the obtained idle resources, the bidding system provides the idle resources through bidding. In this way, the resource usage of the FaaS platform is optimized.
Step 2: As shown in S405 in FIG. 4, after the batch processing service that needs to be executed is selected in step 1, the bidding system invokes a function running module to execute a related batch processing function.
Step 3: The FaaS platform can obtain extra profits from the idle resources sold in steps 1 and 2, and the bidding system uses a part of the extra profits to reduce costs of using an online service. Specifically, as shown in S501 to S504 in FIG. 5, the bidding system adjusts, based on the extra profits, a ratio (supply ratio, a ratio of parts offered at a discount) of online services offered at a discount, and mainly calculates, based on the profits, a quantity of resources (CPU and memory) offered at a discount. This prevents the platform from obtaining a negative profit after these operations, and allows the user to obtain more computing resources at same costs.
Step 4: After a number of discounts that can be obtained for resources of the online service is calculated in step 3, the bidding system sells the resources at a discount in a bidding manner.

A price of the online service is still determined based on a bid of the user and a running status of a function. After the bidding is successful, the bidding system inputs a preferential price (a first price) obtained through calculation to a billing manager, and the billing manager performs charging based on the preferential price and reports charging data.

The FaaS platform performs steps 1 to 4 to sell idle resources to improve resource utilization when the platform is idle; and the FaaS platform implements dynamic charging on the online service, to reduce use costs of the user and improve cost-effectiveness. In this way, more customers are attracted, and overall usage of the platform is improved.

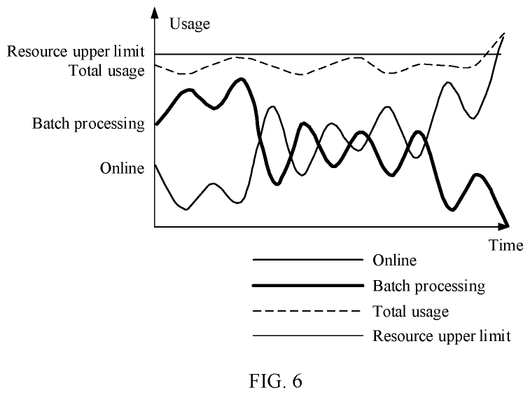

After the foregoing process, an ideal situation reaches a situation shown in FIG. 6. FIG. 6 shows a changing trend of usage of the FaaS platform. In FIG. 6, a horizontal axis represents time, and a vertical axis represents the usage of the FaaS platform. As shown in FIG. 6, an initial curve of the usage of the platform, for example, an online curve, fluctuates greatly, and the usage of the FaaS platform is not high. Then, step 1 and step 2 are performed. At this time, a batch processing service is introduced. As shown by a batch processing curve in FIG. 6, the usage of the platform is compensated during idle hours. After steps 3 and 4 are performed, overall usage of the platform also increases, a final ideal curve of the usage of the platform is shown in, for example, a total usage curve, and the overall usage of the platform is high and stable.

In FIG. 6, the online curve represents usage of the online service when the platform does not take any action. The batch processing curve indicates usage of the batch processing service usage after idle resources are sold. The total usage curve represents overall usage of the platform after a corresponding measure is taken. A maximum (max) value of a curve represents an upper limit of resources of the platform.

When a user requests bidding, the user enters a service type, instance information, and bidding information. Each type of information entered by the user is as follows.

### (1) Service Type

The platform determines whether the service type is an online service or a batch processing service based on a service feature. The online service and the batch processing service are examples of service types. More types of services may be provided in the future.

### (2) Instance Information

The instance information is information related to a serverless application. The instance information includes function information and resource information. If a service type is a batch processing service, a user still needs to provide maximum duration of a function. The platform starts the function instance based on the information.

### (3) Bidding Information

The bidding information includes a bidding trigger condition and a bidding setting, as shown in the following.

### (3-1) Bidding Trigger Condition

If a service type is an online service, a user may participate in every time of bidding by default (a bidding cycle is usually once every hour). If a service type is a batch processing service, the user needs to set the bidding trigger condition.

For the batch processing service, the bidding trigger condition includes but is not limited to the following methods.

Setting method a: The user sets to participate in bidding on idle resources when usage of the platform is low by using a scheduled task (cron, a scheduled execution tool in Linux) expression. In this case, the idle resources may be obtained at a lower price.

Set method b: Event triggering. When a specified event occurs, bidding for the batch processing service is triggered to start.

### (3-2) Bidding Setting

The bidding setting includes a fixed bidding mode and a floating bidding mode. The fixed bidding mode means a same price is offered at every time of bidding. The floating bidding mode means the user may set a price in a future bidding time period through an array.

The following describes the bidding modes of the platform in a cloud function scenario with reference to two examples. The following two examples are examples of the method shown in FIG. 2, where a user i is an example of the first user, bᵢ is an example of the bid of the first user, a function value vᵢ is an example of the value of the first cloud service instance, and dᵢ is an example of the resource usage of the first user.

### Example 1

A bidding process on the FaaS platform is as follows: A user submits a bidding application based on a function (an online service or a batch processing service has different submission entries) of the user. The platform performs bidding based on the received bidding application, a status of resource usage of the platform, and a sales condition.

Example 1 provides a concept: a future function. The future function is a function that enjoys a discounted price in the future. In a process of bidding for the future function, the user offers a bid on the future function. If the bid of the user is accepted by the platform, the platform charges based on the discounted price. If the bid of the user is rejected by the platform, the platform still uses an initial price for charging.

A bidding method specifically includes: It is assumed that the FaaS platform provides a function service with a low price on resources in a time period (t, t+1), and all users may participate in bidding. In the bidding, the user i provides a desired price bᵢ (that is, a bid of the user i). After the user i submits the bid to the platform, the platform integrates historical data of the user i and the bid of the user i into a bidding triplet. Bᵢ=(dᵢ, rᵢ, bᵢ). The platform executes a bidding algorithm based on the bidding triplet to determine a successful bidder and a price.

dᵢ indicates a resource consumed by the user i in a historical time period:

$${d}_{i} = \frac{1}{{x}_{i}^{′}} {\sum }_{n = 1}^{{x}_{i}^{′}} {d}_{i}^{n} ,$$

where x₁′ is a quantity of times that a function is historically invoked, and dᵢⁿ is actual resource utilization of the user i when a function is invoked for an n^{th} time. The resource utilization includes but is not limited to utilization of a virtual processor (for example vCPU), utilization of a memory, or utilization of another resource.

rᵢ represents a resource applied for by the user i for a function in a historical time period: rᵢ=Σₙ₌₁^{x′}^{ᵢ}Rᵢⁿlᵢⁿ, where Rᵢⁿ represents a resource applied for by the user i for invoking the function for the n^{th} time, and lᵢⁿ represents a historical quantity of execution times of a function i.

bᵢ indicates the bid of the user i.

The bidding algorithm optionally uses an auction algorithm. The auction algorithm is theoretically proven. For the bidding function, a concept of a function value is provided in this embodiment. Function value vᵢ=(rᵢ×bᵢ)/dᵢ. The bidding triplet is simplified into the following 2-tuple by using the function value: (a quantity of applied resources, a function value), that is, (rᵢ, vᵢ). The following two steps are performed based on the 2-tuple, to implement bidding.
Step 1: Select a successful bidder.

Optionally, the successful bidder is selected by using a greedy algorithm. Specifically, bids of users are first sorted in descending order of function values. Then, one or more users whose total quantity of applied resources is closest to a set total quantity of resources are selected, as the successful bidder, from the sorted users based on quantities of resources applied for by the users.

The user whose total quantity of applied resources is closest to the set total quantity of resources is selected as the successful bidder. In one aspect, this allows more users to obtain a discount. In another aspect, this ensures that a quantity of resources provided through bidding does not exceed a quantity of resources that are provided at a discount and that are allowed by the platform, to avoid a negative profit of the platform.
Step 2: Determine a price.

Because different users offer different prices, a suitable price needs to be selected as a price for the successful bidder. A price selection manner includes steps 2-1 and 2-2.
Step 2-1: Remove a user with a highest function value from all the users participating in bidding, and perform a new round of bidding based on remaining users. In other words, the successful bidder is re-selected when the user with the highest function value does not participate in the bidding.

The user with the highest function value is removed when the price is determined. Therefore, a bid of the user with the highest function value does not affect a final price.
Step 2-2: Select, as the final price, a function value of a user with a highest function value from users other than the re-selected successful bidder.

The function value is used as the final price. This can avoid a situation that a user obtains an extra benefit by randomly offering a bid.

In the foregoing bidding manner provided in this embodiment, the successful bidder is selected based on the function value, and a user with lower resource usage has a higher virtual value. Therefore, a probability of selecting the user with the lower resource usage as the successful bidder is high. In this way, the user with the low resource usage can be given more bidding rights. Because function values are sorted when a price is determined, it is ensured that each successful bidder can get a lower price than an original price.

The following uses an example to describe the bidding algorithm.

In the following example, a total quantity of resources auctioned is 100 GB, and a total of five users participate in bidding. A bidding process includes step 1 to step 5.
Step 1: A user offers a bid.

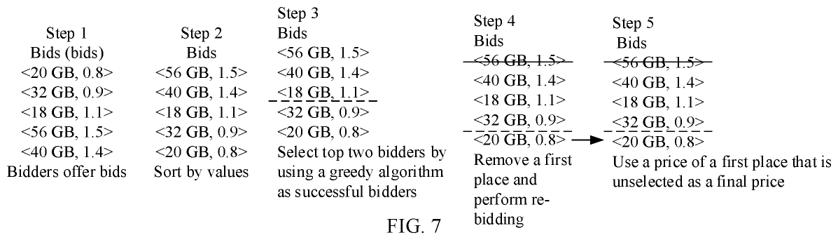

As shown in FIG. 7, in a bid column, a first column is quantities of resources applied for by the five users, and a second column is a function value of each user in the five users. Specifically, a quantity of resources applied for by a user 1 is 20 GB, and a function value of the user 1 is 0.8. A quantity of resources applied for by a user 2 is 32 GB, and a function value of the user 2 is 0.9. A quantity of resources applied for by a user 3 is 18 GB, and a function value of the user 3 is 1.1. A quantity of resources applied for by a user 4 is 56 GB, and a function value of the user 4 is 1.5. A quantity of resources applied for by a user 5 is 40 GB, and a function value of the user 5 is 1.4.
Step 2: Sort the users based on a function value of each user.

As shown in FIG. 7, because the function value (1.5) of the user 4 is highest between the five users, the user 4 ranks first; because the function value (1.4) of the user 5 is second highest, the user 4 ranks second; and the rest can be deduced by analogy, and because the function value (0.8) of the user 1 is lowest between the five users, the user 4 ranks last.
Step 3: Select a successful bidder from the sorted users by using a greedy algorithm.

Between the sorted users, a quantity of resources applied for by the user 4 ranked first is 56 GB, a total quantity of resources applied for by the user 4 ranked first and resources applied for by the user 5 ranked second is (56 GB+40 GB)=96 GB, and a total quantity of resources applied for by the user 4 ranked first, resources applied for by the user 5 ranked second, and resources applied for by the user 3 ranked third is (56 GB+40 GB+18 GB)=114 GB. Since a total quantity of resources auctioned is 100 GB, a total quantity (96 GB) of resources applied for by the user 4 and the user 5 is the closest to the total quantity of resources auctioned (100 GB) and does not exceed the total quantity of resources auctioned. Therefore, the first two users (the user 4 and the user 5) are selected as successful bidders.
Step 4: Remove a user with a highest function value from the users sorted in step 2, and perform re-bidding.

Specifically, because a function value of the user 4 with a quantity 56 GB of applied resources and a function value 1.5 ranks first, the user 4 is removed. If the user 4 does not participate in the bidding, the other four users participate in a new round of bidding again. A process of re-bidding is the same as that of step 3. In this case, the second, third, and fourth places (which respectively are the user 5 with the function value 1.4, the user 3 with the function value 1.1, and the user 2 with the function value 0.9) win the bidding.
Step 5: Use a function value of a first user in unselected users as a final transaction price of a function.

Specifically, the function value (0.8) of the fifth place (the user 1) is used as the final price. Because the function value of the fifth place is less than or equal to function values of the first four users, the final price obtained by a successful bidder is certainly lower than a bid provided by the successful bidder.

The foregoing bidding method has a great preference for a user with low resource usage. This compensates the user for a loss of wasted resources.

According to the method provided in the foregoing Example 1, for an online service, a resource required for processing the online service is provided through bidding. This gives the online service a discount, and helps a user reduce costs. Therefore, more users are attracted to migrate to a cloud platform. For a batch processing service, idle resources are sold to the batch processing service through bidding, and the user may select to start the batch processing service by using the idle resources auctioned when the platform is idle, to obtain a more favorable price than normal (that is, when the platform is not idle). Therefore, peak shaving and valley filling is implemented on resource usage. In addition, the bidding algorithm compensates a user with low actual resource usage, helps the user with the low actual resource usage reduce use costs, and compensates for unfairness of resources in the billing mode.

### Example 2

Example 2 is similar to Example 1, and Example 2 provides another function bidding mode, as shown below.

Example 2 provides a concept: a discount function. The discount function is a function that can enjoy a discounted price in a period of time in the past. A user offers a bid on the function. The platform analyzes content such as a quantity of times that a function is invoked and resource usage of the function in the past period of time, and gives a discount to a function that is frequently invoked. If the platform accepts the bid, a fee for the function over the past period is waived based on a discounted price. If the platform does not accept the bid, the function is still charged at an original price.

It is assumed that the FaaS platform provides a function service with a low price on resources in a time period (t, t+1). After the user offers the bid, the FaaS platform determines which function obtains a discount at the time period (t+1) based on an execution status of the bidding function in the time period (t, t+1). A bidding method is as follows.

All users (an online or offline service) can bid for the function, and a user provides a desired price bᵢ (that is, a bid of the user).

After the user i submits the bid bᵢ to the platform, the platform integrates the bid bᵢ of the user i, a resource r applied for by the user for the function, and execution duration of the function into a bidding triplet: Bᵢ=(tᵢ, rᵢ, bᵢ).

tᵢ represents actual execution time at which the user i executes the function in the time period (t, t+1). Actual execution time=An actual quantity of times that a function is invoked×Average execution time of the function. The actual execution time may be understood as accumulated execution time of the function in the time period (t, t+1). rᵢ represents a resource actually applied for by a user for the function in the time period (t, t+1): rᵢ=Σₙ₌₁^{x′}^{ᵢ}Rᵢⁿlᵢⁿ, where Rᵢⁿ represents a resource actually applied for when the function is invoked for an nth time, and lᵢⁿ represents a quantity of execution times of the function i in this time period. bᵢ indicates the bid of the user i.

A supplier guarantees that a price that can be obtained by a user that obtains a discount is lower than an original price.

An algorithm of the bidding mode is used to ensure that the platform can obtain a maximum profit in the time period (t, t+1). The bidding mode includes step 1 and step 2.
Step 1: Select a successful bidder. Step 2: Determine a price.

Function value vᵢ=tᵢ×bᵢ. The function value indicates revenue that can be obtained by each resource unit in a specified period.

A bidding triplet is simplified into a 2-tuple (a quantity of applied resources and a function value), and an auction algorithm is used for auction based on the 2-tuple. The bidding manner of Example 2 is the same as that of Example 1, and auction is also performed by using the auction algorithm. Refer to the introduction of Example 1.

Because Example 2 starts bidding after function execution is complete, Example 2 is usually not suitable for a case in which an application volume of batch processing services is greater than usage of idle resources, and is suitable for preferential bidding of an online service.

In the bidding process provided in Example 2, because the bidding process is performed after the function is executed, the bidding process does not affect function execution. In the bidding process, the platform evaluates based on a function running status during this period. Theoretically, a function that is invoked for a large quantity of times and that is invoked for long time in a single invocation has a greater advantage in bidding. Therefore, a user with high usage has a higher probability of obtaining a discount. In this way, use costs of the user with the high usage are effectively reduced, and a phenomenon of cost explosion that may occur after usage increases is prevented.

The bidding methods shown in Example 1 and Example 2 may be applied to various serverless applications, and a cloud function scenario is merely an example. The bidding methods shown in Example 1 and Example 2 may also be applied to another serverless application other than a cloud function, for example, applied to a serverless container service.

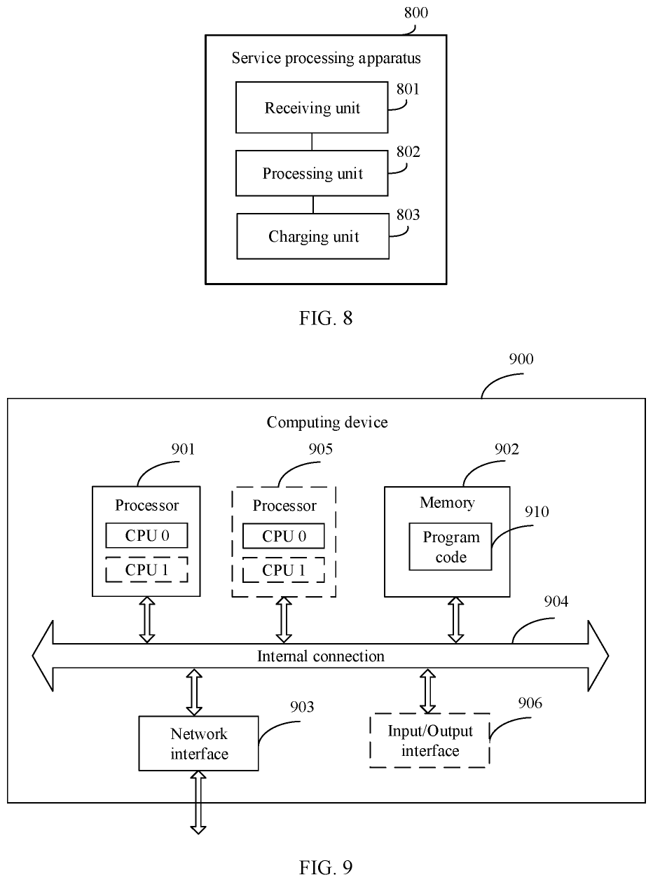

FIG. 8 is a schematic diagram of a structure of a service processing apparatus according to an embodiment of this application. A service processing apparatus 800 shown in FIG. 8 is configured to implement the method shown in FIG. 2, FIG. 4, FIG. 6, or FIG. 7.

Optionally, with reference to the application scenario shown in FIG. 1, the service processing apparatus 800 shown in FIG. 8 is disposed on the server 1041 or the server 1042 in the cloud platform 104 in FIG. 1.

The service processing apparatus 800 includes a receiving unit 801, a processing unit 802, and a charging unit 803. The receiving unit 801 is configured to support the service processing apparatus 800 in performing S201. The processing unit 802 is configured to support the service processing apparatus 800 in performing S202. The charging unit 803 is configured to support the service processing apparatus 800 in performing S203 and S204.

The apparatus embodiment described in FIG. 8 is merely an example. For example, division into the units is merely logical function division and may be other division in actual implementation. For example, a plurality of units or components may be combined or integrated into another system, or some features may be ignored or not performed. Functional units in embodiments of this application may be integrated into one processing unit, each of the units may exist alone physically, or two or more units are integrated into one unit.

All or some of the units in the service processing apparatus 800 are implemented by using software, hardware, firmware, or any combination thereof.

When the units are implemented by using software, for example, the processing unit 802 and the charging unit 803 are implemented by software functional units generated by at least one processor 901 in FIG. 9 after the processor 901 reads program code stored in a memory 902.

When the units are implemented by using hardware, for example, the foregoing units in FIG. 8 are separately implemented by different hardware in a computing device. For example, the processing unit 802 is implemented by a part of processing resources (for example, one core or two cores in a multi-core processor) in the at least one processor 901 in FIG. 9, and the charging unit 803 is implemented by remaining resources (for example, other cores in the multi-core processor) in the at least one processor 901 in FIG. 9, or the charging unit 803 is implemented by using a field-programmable gate array (FPGA) or a programmable device such as a coprocessor. The receiving unit 801 is implemented by a network interface 903 in FIG. 9.

When the units are implemented by using a combination of software and hardware, for example, the processing unit 802 is implemented by a hardware programmable device, and the charging unit 803 is a software function unit generated after a CPU reads program code stored in a memory.

The following describes basic hardware structures related to a cloud platform by using an example.

FIG. 9 is a schematic diagram of a structure of a computing device according to an embodiment of this application. A computing device 900 shown in FIG. 9 is disposed on the cloud platform.

Optionally, with reference to the application scenario shown in FIG. 1, the computing device 900 shown in FIG. 9 is the server 1041 or the server 1042 in the cloud platform 104 in FIG. 1.

Optionally, the computing device 900 shown in FIG. 9 is configured to perform the method shown in FIG. 2, FIG. 4, FIG. 6, or FIG. 7.

The computing device 900 includes at least one processor 901, a memory 902, and at least one network interface 903.

The processor 901 is, for example, a general-purpose central processing unit (CPU), a network processor (NP), a graphics processing unit (GPU), a neural-network processing unit (NPU), a data processing unit (DPU), a microprocessor, or one or more integrated circuits configured to implement the solutions of this application. For example, the processor 901 includes an application-specific integrated circuit (ASIC), a programmable logic device (PLD), or a combination thereof. The PLD is, for example, a complex programmable logic device (CPLD), a field-programmable gate array (FPGA), generic array logic (GAL), or any combination thereof.

The memory 902 is, for example, a read-only memory (ROM) or another type of static storage device that can store static information and instructions, a random access memory (RAM) or another type of dynamic storage device that can store information and instructions, or an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, and the like), a magnetic disk storage medium or another magnetic storage device, or any other medium that can be used to carry or store expected program code in an instruction or data structure form and that can be accessed by a computer, but the memory 902 is not limited thereto. Optionally, the memory 902 exists independently, and is connected to the processor 901 by using an internal connection 904. Alternatively, optionally, the memory 902 and the processor 901 are integrated together.

The network interface 903 uses any apparatus such as a transceiver, and is configured to communicate with another device or a communication network. The network interface 903 includes, for example, at least one of a wired network interface or a wireless network interface. The wired network interface is, for example, an Ethernet interface. The Ethernet interface is, for example, an optical interface, an electrical interface, or a combination thereof. The wireless network interface is, for example, a wireless local area network (WLAN) interface, a cellular network interface, or a combination thereof.

In some embodiments, the processor 901 includes one or more CPUs, such as a CPU 0 and a CPU 1 shown in FIG. 9.

In some embodiments, the computing device 900 optionally includes a plurality of processors, such as a processor 901 and a processor 905 shown in FIG. 9. Each of these processors is, for example, a single-core processor (single-CPU), or a multi-core processor (multi-CPU). Optionally, the processor herein refers to one or more devices, circuits, and/or processing cores configured to process data (for example, computer program instructions).

In some embodiments, the computing device 900 also includes the internal connection 904. The processor 901, the memory 902, and the at least one network interface 903 are connected by using the internal connection 904. The internal connection 904 includes pathways to communicate information between the components described above. Optionally, the internal connection 904 is a board or a bus. Optionally, the internal connection 904 is divided into an address bus, a data bus, a control bus, and the like.

In some embodiments, the computing device 900 further includes an input/output interface 906. The input/output interface 906 is connected to the internal connection 904.

Optionally, the processor 901 implements the method in the foregoing embodiment by reading program code 910 stored in the memory 902, or the processor 901 implements the method in the foregoing embodiment by using internally stored program code. When the processor 901 implements the method in the foregoing embodiment by reading the program code 910 stored in the memory 902, the memory 902 stores the program code for implementing the method provided in embodiments of this application.

For more details of implementing the foregoing functions by the processor 901, refer to descriptions in the foregoing method embodiments. Details are not repeated herein.

Embodiments in this specification are all described in a progressive manner. For same and similar parts in embodiments, refer to these embodiments. Each embodiment focuses on a difference from another embodiment.

A refers to B, which means that A is the same as B or A is a simple variant of B.

In the specification and claims of embodiments of this application, the terms “first”, “second”, and the like are used to distinguish between different objects, but are not used to describe a specific order of the objects, and cannot be understood as indicating or implying relative importance. For example, a first resource and a second resource are used to distinguish between different resources, but are not used to describe a specific order of resources. It cannot be understood that the first resource is more important than the second resource.

In embodiments of this application, unless otherwise specified, “at least one” means one or more, and “a plurality of” means two or more. For example, a plurality of service requests refer to two or more service requests.

All or some of the foregoing embodiments may be implemented by using software, hardware, firmware, or any combination thereof. When the foregoing embodiments are implemented by using software, all or a part of embodiments may be implemented in a form of a computer program product. The computer program product includes one or more computer instructions. When the computer program instructions are loaded and executed on a computer, all or some of the procedures or functions according to embodiments of this application are generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium that can be accessed by a computer, or may be a data storage device, such as a server or a data center, integrating with one or more usable media. The usable medium may be a magnetic medium (for example, a floppy disk, a hard disk, or a magnetic tape), an optical medium (for example, a DVD), a semiconductor medium (for example, a solid state drive (SSD)), or the like.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

What is claimed is:

1. A service processing method, the method comprises:
receiving a plurality of service requests, wherein the plurality of service requests indicate to process a plurality of services corresponding to a plurality of users, and each of the plurality of service requests indicates a cloud platform to process a service indicated by the respective service request;
processing the plurality of services corresponding to the plurality of service requests, and bidding on resources applied for by the plurality of users, wherein a resource applied for by each of the plurality of users is used to process a service that corresponds to the respective user and that is in the plurality of services;
charging, based on a first price, a user that wins bidding and that is in the plurality of users, wherein a value of the first price is related to bids of one of more users of the plurality of users, and the first price is lower than a bid of any user that wins the bidding and that is in the plurality of users; and
charging, based on a second price, a user that loses the bidding and that is in the plurality of users, wherein the second price is higher than the first price, and the cloud platform continues processing on a service corresponding to the user that loses the bidding and that is in the plurality of users.

2. The method according to claim 1, wherein the plurality of services corresponding to the plurality of service requests comprise a batch processing service; and
the processing the plurality of services corresponding to the plurality of service requests comprises:
allocating a first resource in a first time period to the batch processing service, wherein the first time period is a time period in which resource usage of the cloud platform is lower than a threshold, and the first resource is idle in the first time period; and
processing the batch processing service by using the first resource within the first time period.

3. The method according to claim 2, wherein the first time period is determined based on a change status of the resource usage of the cloud platform during historical use.

4. The method according to claim 1, wherein the plurality of services corresponding to the plurality of service requests comprise an online service; and the processing the plurality of services corresponding to the plurality of service requests comprises:
allocating a second resource to the online service in real time, wherein a quantity of second resources is related to the first price, and
processing the online service by using the second resource.

5. The method according to claim 1, wherein the plurality of users comprise a first user, whether the first user wins the bidding is related to a value of a first cloud service instance, the first cloud service instance is a cloud service instance used when a service corresponding to the first user is processed, the value of the first cloud service instance indicates a benefit brought by the first cloud service instance to the cloud platform and a benefit brought by the first cloud service instance to the first user, and the value of the first cloud service instance is related to at least one of a bid of the first user, resource usage of the first user, or a quantity of times that the first cloud service instance is invoked.

6. The method according to claim 5, wherein the value of the first cloud service instance is directly proportional to the bid of the first user, the value of the first cloud service instance is inversely proportional to the resource usage of the first user, and the value of the first cloud service instance is directly proportional to the quantity of times that the first cloud service instance is invoked.

7. The method according to claim 5, wherein the first price is related to the value of the first cloud service instance.

8. The method according to claim 1, wherein the plurality of users comprise a first user, whether the first user wins the bidding is related to a bid of the first user and resource usage of the first user, and the first price is further related to the resource usage of the first user.

9. The method according to claim 1, wherein the plurality of users comprise a first user, whether the first user wins the bidding is related to a bid of the first user and a quantity of times that a first cloud service instance is invoked, the first price is further related to the quantity of times that the first cloud service instance is invoked, and the first cloud service instance is a cloud service instance used when a service corresponding to the first user is processed.

10. The method according to claim 5, wherein the first cloud service instance is a function, a container, or a virtual machine.

11. The method according to claim 1, wherein the bidding is triggered in at least one of the following manners: a time triggering manner, a resource usage triggering manner, or an event triggering manner.

12. A device comprising:
a memory configured to store instructions; and
one or more processors coupled to the memory and configured to execute the instructions to cause the device to:
receive a plurality of service requests, wherein the plurality of service requests indicate to process a plurality of services corresponding to a plurality of users, and each of the plurality of service requests indicates a cloud platform to process a service indicated by the respective service request;
process the plurality of services corresponding to the plurality of service requests, and bidding on resources applied for by the plurality of users, wherein a resource applied for by each of the plurality of users is used to process a service that corresponds to the respective user and that is in the plurality of services;
charge, based on a first price, a user that wins bidding and that is in the plurality of users, wherein a value of the first price is related to bids of one or more users of the plurality of users, and the first price is lower than a bid of any user that wins the bidding and that is in the plurality of users; and
charge, based on a second price, a user that loses the bidding and that is in the plurality of users, wherein the second price is higher than the first price, and the cloud platform continues processing on a service corresponding to the user that loses the bidding and that is in the plurality of users.

13. The device according to claim 12, wherein the plurality of services corresponding to the plurality of service requests comprise a batch processing service; and
the instructions cause the device to:
allocate a first resource in a first time period to the batch processing service, wherein the first time period is a time period in which resource usage of the cloud platform is lower than a threshold, and the first resource is idle in the first time period; and
process the batch processing service by using the first resource within the first time period.

14. The device according to claim 13, wherein the first time period is determined based on a change status of the resource usage of the cloud platform during historical use.

15. The device according to claim 12, wherein the plurality of services corresponding to the plurality of service requests comprise an online service; and the processing the plurality of services corresponding to the plurality of service requests, further cause the device to:
allocate a second resource to the online service in real time, wherein a quantity of second resources is related to the first price, and
process the online service by using the second resource.

16. A non-transitory computer-readable storage medium storing computer-executable instructions, wherein the computer-executable instructions, when executed by one or more processors of an apparatus, cause the apparatus to:
receive a plurality of service requests, wherein the plurality of service requests indicate to process a plurality of services corresponding to a plurality of users, and each of the plurality of service requests indicates a cloud platform to process a service indicated by the respective service request;
process the plurality of services corresponding to the plurality of service requests, and bidding on resources applied for by the plurality of users, wherein a resource applied for by each of the plurality of users is used to process a service that corresponds to the respective user and that is in the plurality of services;
charge, based on a first price, a user that wins bidding and that is in the plurality of users, wherein a value of the first price is related to bids of one or more users of the plurality of users, and the first price is lower than a bid of any user that wins the bidding and that is in the plurality of users; and
charge, based on a second price, a user that loses the bidding and that is in the plurality of users, wherein the second price is higher than the first price, and the cloud platform continues processing on a service corresponding to the user that loses the bidding and that is in the plurality of users.

17. The non-transitory computer-readable storage medium according to claim 16, wherein the plurality of services corresponding to the plurality of service requests comprise a batch processing service; and
the processing the plurality of services corresponding to the plurality of service requests, further cause the apparatus to:
allocating a first resource in a first time period to the batch processing service, wherein the first time period is a time period in which resource usage of the cloud platform is lower than a threshold, and the first resource is idle in the first time period; and
processing the batch processing service by using the first resource within the first time period.

18. The non-transitory computer-readable storage medium according to claim 17, wherein the first time period is determined based on a change status of the resource usage of the cloud platform during historical use.

19. The non-transitory computer-readable storage medium according to claim 16, wherein the plurality of services corresponding to the plurality of service requests comprise an online service; and the computer-executable instructions, when executed, cause the apparatus to:
allocate a second resource to the online service in real time, wherein a quantity of second resources is related to the first price, and
process the online service by using the second resource.

20. The non-transitory computer-readable storage medium according to claim 16, wherein the plurality of users comprise a first user, whether the first user wins the bidding is related to a value of a first cloud service instance, the first cloud service instance is a cloud service instance used when a service corresponding to the first user is processed, the value of the first cloud service instance indicates a benefit brought by the first cloud service instance to the cloud platform and a benefit brought by the first cloud service instance to the first user, and the value of the first cloud service instance is related to at least one of a bid of the first user, resource usage of the first user, or a quantity of times that the first cloud service instance is invoked.
